(19) United States
(12) Patent Application Publication
(10) Pub. No.: US 2007/0132331 A1
(43) Pub. Date: Jun. 14, 2007

(54) DC homopolar motor/generator

(75) Inventor: Jack Kerlin, Springdale, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: RT Patent Company, Inc.

(21) Appl. No.: 11/300,246

(22) Filed: Dec. 13, 2005

(51) Int. Cl. H02K 49/00; H02K 31/00

(52) U.S. Cl. 310/178; 310/102 A

(57) ABSTRACT

In accordance with the teachings described herein, a DC homopolar machine is provided. The DC homopolar machine may include a stator having a stator magnetic core and a permanent magnet, a rotor magnetic core supported within the stator to rotate relative to the stator, and non-magnetic material within a gap between the rotor magnetic core and the stator magnetic core. The stator, rotor and non-magnetic material form a magnetic circuit having a total reluctance, the total reluctance of the magnetic circuit being provided by a first reluctance of the permanent magnet and a second reluctance of the gap of non-magnetic material, with the first reluctance being substantially equal to the second reluctance.

### FIELD

The technology described in this patent document relates generally to electric motors and generators. More particularly, a DC homopolar machine is described that is particularly useful for applications requiring a high energy efficiency.

### BACKGROUND

The earliest electromotive machine producing rotary shaft power was the homopolar motor/generator. Conversion of electric power into mechanical shaft power was first demonstrated by Michael Faraday in the early 19th century. Variously known as a “homopolar,” “unipolar” or “monopolar” machine, this unique energy conversion device represents a true DC machine requiring no commutator or other switching methods for converting direct current into alternating current as required by conventional so-called “DC” machines. The standard homopolar motor/generator is a single-turn machine requiring very high current at just a few volts. This peculiar characteristic of a homopolar machine renders it impractical for most commercial applications.

Creation of the magnetic field in a DC homopolar machine is readily facilitated by permanent magnet (PM) material. Historically, PM-based homopolar machine design has focused on creating the highest possible flux content from a given quantity of PM material. This design philosophy derives from the understanding that torque is directly proportional to total magnetic flux. Accordingly, the rotor-stator gap is typically kept as small as practicable in order to increase total flux content. Typical machines consequently embody a relatively small rotor-stator gap which in turn restricts the amount of copper available for current conduction through the rotor-stator gap region. Excessive heat production and low efficiency typically ensue as a result of reduced copper volume.

### SUMMARY

In accordance with the teachings described herein, a DC homopolar machine is provided. The DC homopolar machine may include a stator having a stator magnetic core and a permanent magnet, a rotor magnetic core supported within the stator to rotate relative to the stator, and non-magnetic material within a gap between the rotor magnetic core and the stator magnetic core. The stator, rotor and non-magnetic material form a magnetic circuit having a total reluctance. The total reluctance of the magnetic circuit is provided by a first reluctance of the permanent magnet and a second reluctance of the gap of non-magnetic material, with the first reluctance being substantially equal to the second reluctance.

### BRIEF DESCRIPTION OF THE DRAWINGS

FIG. 1 depicts a simple magnetic circuit that includes an ideal iron core of infinite permeability interrupted with two gaps.

FIG. 2 depicts a cross-sectional view of an example DC homopolar motor/generator.

FIG. 3 depicts an example external view of the DC homopolor motor/generator shown in FIG. 2.

### DETAILED DESCRIPTION

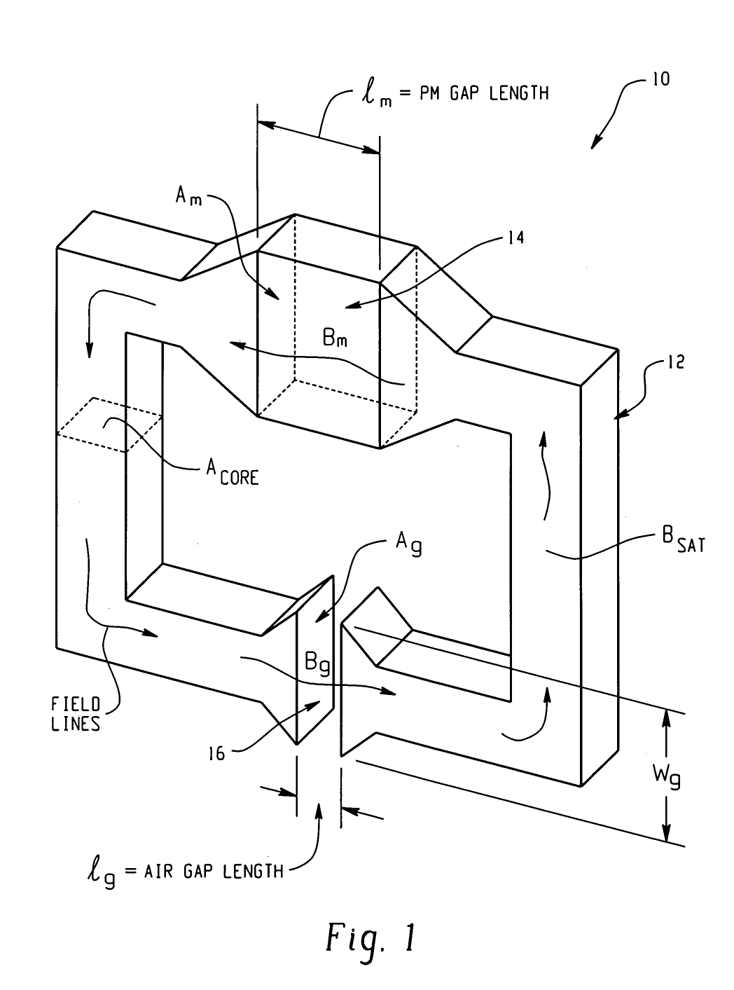

FIG. 1 shows a simple magnetic circuit 10 that includes an ideal iron core 12 of infinite permeability interrupted with two gaps 14, 16. One gap 14 is filled with PM material and the other gap 16 is filled at least partial with copper conductors. Relative permeability of the PM gap 14 is nearly twice that of free space or air. The PM material 14 provides magnetomotive force (mmf) for driving flux through both its own reluctance and the reluctance of the other gap 16. The latter gap 16 is referred to herein as the “air gap” even though in an actual machine application it may be mostly filled with copper conductors. Copper has a relative permeability nearly that of air. Permanent magnets are rated for their “closed circuit” flux density which falls off when an air gap is added to the circuit due to the resulting rise of overall circuit reluctance. Thus, the actual gap flux density will always be less than the rated PM value depending on the magnitude of the additional air gap length.

Referring to FIG. 1, let the fundamental (mmf)_{cc} arising from the PM material be represented as:

$${( mmf )}_{cc} = {( ni )}_{cc} = \frac{{B}_{R} {l}_{m}}{{μ}_{r} {μ}_{o}} ; \qquad Eq . 1$$

where:
(ni_{cc})=equivalent “closed circuit” amp-turns or mmf of PM material that drives flux through the circuit;
B_{R}=so-called “Residual Induction”, the rated flux density of PM material in a closed circuit;
lₘ=gap length occupied by the PM material;
μᵣ=relative magnetic permeability of PM material, where a value of “unity” represents free space (air); and
μₒ=absolute permeability of free space (air essentially).
   The magnetic circuit equation, similar in form to Ohm's Law, is:
   (ni)_{cc}=φ [symbol] ₜₒₜ; Eq. 2
   where:
φ=circuit flux which has the same value at all points in the circuit, thus no subscript; and
[symbol] ₜₒₜ=total circuit reluctance including both the air gap and the gap occupied by PM material.
Total circuit reluctance [symbol] ₜₒₜ is the summation of reluctance contributed by each gap, [symbol] ₘ and [symbol] _{g} where:

$${R}_{tot} = ( {R}_{m} + {R}_{g} ) + ( \frac{{l}_{m}}{{μ}_{r} {μ}_{o} {A}_{m}} + \frac{{l}_{g}}{{μ}_{o} {A}_{g}} ) ; \qquad Eq . 3$$

where:
[symbol] ₘ=reluctance of gap occupied by PM material;
[symbol] _{g}=reluctance of air gap (occupied by copper conductors);
Aₘ=gap area filled with PM material;
l_{g}=length of air gap; and
A_{g}=area of air gap.
The first term in Eq. 3 represents reluctance of the gap 14 holding PM material; the second term is the reluctance of the air gap 16 containing the copper conductors.
Substituting Eq. 3 into Eq. 2:

$${( ni )}_{cc} = ϕ ( \frac{{l}_{m}}{{μ}_{r} {μ}_{o} {A}_{m}} + \frac{{l}_{g}}{{μ}_{o} {A}_{g}} ) \qquad Eq . 4$$

Substituting Eq. 1 into Eq. 4:

$$\frac{{B}_{R} {l}_{m}}{{μ}_{r} {μ}_{o}} = ϕ ( \frac{{l}_{m}}{{μ}_{r} {μ}_{o} {A}_{m}} + \frac{{l}_{g}}{{μ}_{o} {A}_{g}} ) \qquad Eq . 5$$

The total circuit flux φ is the same everywhere, thus:
φ=AₘBₘ=A_{g}B_{g}=A_{core}Bₛₐₜ; Eq. 6
where:
Bₘ=flux density of PM gap under non-closed circuit conditions;
B_{g}=flux density of air gap;
A_{core}=area of the circuit iron core connecting the two gaps; and
Bₛₐₜ=saturation flux density of the interconnecting core.

Core area A_{core} is the minimum value required to carry flux φ at the maximum saturation flux density in order to reduce circuit weight and achieve optimum core material (iron) utilization.

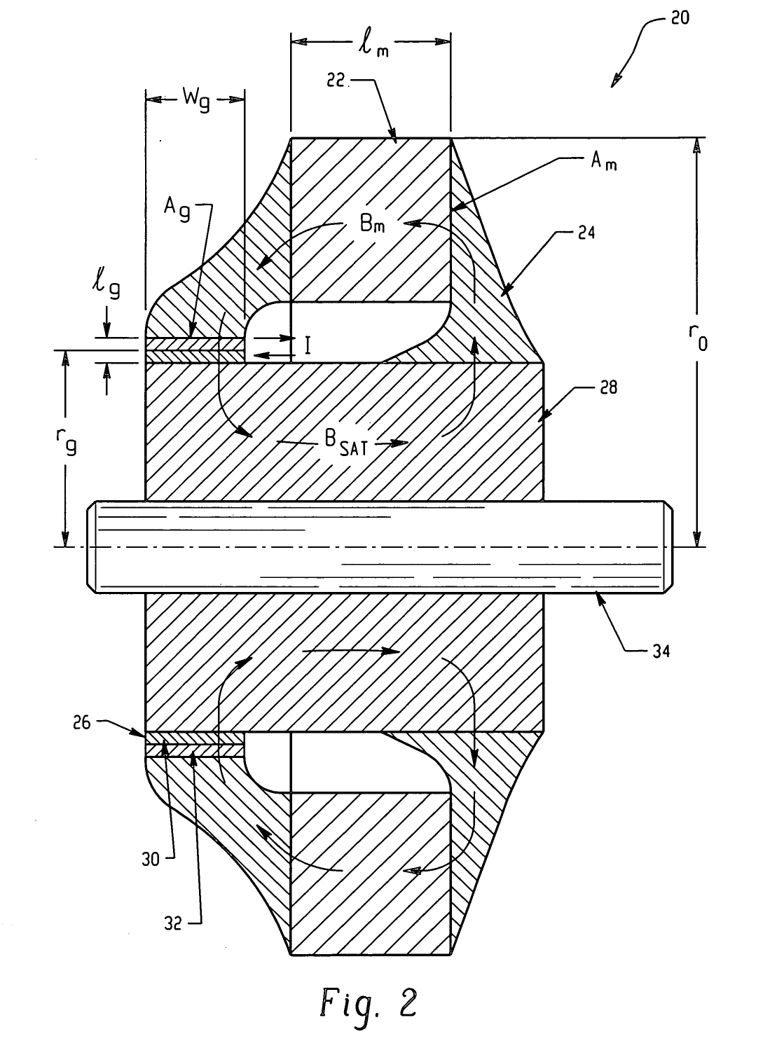

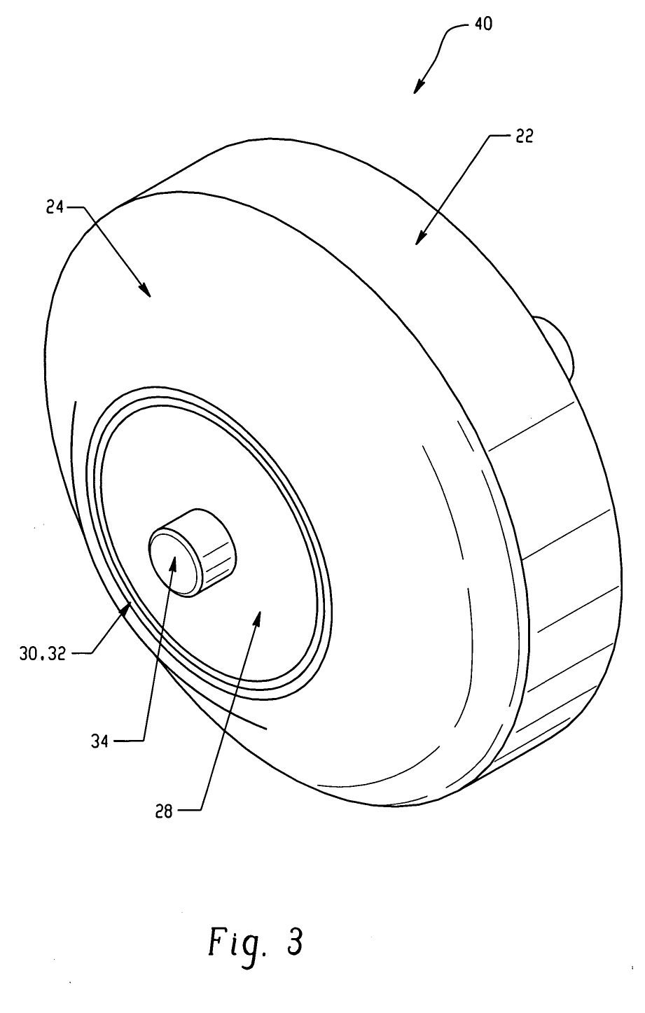

FIG. 2 depicts a cross-sectional view of an example DC homopolar machine 20. The example machine 20 depicted in FIG. 2 includes physical features that correspond to the magnetic circuit 10 depicted in FIG. 1. Specifically, the example homopolar machine includes a stator having a stator iron core 24 and a permanent magnet 22, a rotor magnetic core 28 supported within the stator 22, 24 to rotate relative to the stator, and non-magnetic material within a rotor-stator gap 26 between the rotor magnetic core 28 and the stator magnetic core 24. Also illustrated is a shaft 34 connected to the rotor 28. The non-magnetic material within the rotor-stator gap 26 depicted in this example includes a rotor copper conductor 30 and a stator copper conductor 32. The non-magnetic material in the rotor-stator gap 26 also includes at least a small gap filled with air, such that the rotor 28 may rotate relative to the stator 24. It should be understood, however, that in other examples the non-magnetic material within the rotor-stator gap 26 may include a larger gap of air, or may be entirely air without any copper conductors. In addition, other examples may include non-magnetic material within the rotor-stator gap 26 other than copper or air. FIG. 3 depicts an example external view of the DC homopolor motor/generator shown in FIG. 2.

As described in more detail with reference to the equations provided below, the stator 22, 24, rotor 28 and rotor-stator gap 26 form a magnetic circuit. The total reluctance of the magnetic circuit is provided by a first reluctance of the permanent magnet 22 and a second reluctance of the rotor-stator gap 26, with the first reluctance being substantially equal to the second reluctance. It should be understood that the term “substantially equal” is used herein to equate things that are either exactly equal or about equal.

Torque Equation Derivation:

The following equations (Eq. 7-Eq. 12) may be used to express the total machine torque for the example motor/generator depicted in FIGS. 2 and 3. Let motor torque T be given as:
T=Fr_{g}=(IB_{g}w_{g})r_{g}; Eq. 7
where:
F=force developed on rotor conductors;
I=total electric current flowing through all the rotor conductors;

B_{g}=rotor-stator gap magnetic flux density;
w_{g}=length of rotor conductors immersed in the magnetic field; and
r_{g}=rotational radius of rotor conductors.
Let gap area A_{g} be expressed as the length of the gap circumference 2πr_{g} times axial length w_{g}:
A_{g}=(2πr_{g})w_{g} Eq. 8
Solving Eq. 8 for w_{g} and substituting into Eq. 7:

$$T = ( \frac{{IB}_{g} {A}_{g}}{2 π {r}_{g}} ) {r}_{g} = \frac{1}{2 π} {IB}_{g} {A}_{g} \qquad Eq . 9$$

Inserting Eq. 6 into Eq. 9:

$$T = \frac{1}{2 π} I ϕ \qquad Eq . 10$$

Total machine torque T is revealed by Eq. 10 to be a function of two fundamental machine properties, current capacity I, and machine flux capacity φ. Practical limitation of I is dictated by copper content. Maximum flux φ is governed by the iron content. The quantity of copper constrains current to within the thermal limit. Iron quantity limits flux to the saturation level.
Rewriting Eq. 5 while using Eq. 6 for flux φ:

$${B}_{R} {l}_{m} = {A}_{g} {B}_{g} ( \frac{{l}_{m}}{{A}_{m}} + \frac{{μ}_{r} {l}_{g}}{{A}_{g}} ) \qquad Eq . 11$$

Solving Eq. 11 for rotor-stator gap flux B_{g}:

$${B}_{g} = \frac{{B}_{R} {l}_{m}}{{A}_{g} ( \frac{{l}_{m}}{{A}_{m}} + \frac{{μ}_{r} {l}_{g}}{{A}_{g}} )} \qquad Eq . 12$$

Machine Flux as Function of Rotor-Stator Gap:

If μᵣ=1 and Aₘ=A_{g}, then Eq. 12 reduces to:

$${B}_{g} = {B}_{R} ( \frac{{l}_{m}}{{l}_{m} + {l}_{g}} ) = \frac{{B}_{R}}{( 1 + \frac{{l}_{g}}{{l}_{m}} )} ( at {A}_{m} = {A}_{g} , {μ}_{r} = 1 ) \qquad Eq . 13$$

From Eq. 13 it may be shown that gap flux density B_{g} declines from B_{g}=B_{R} at l_{g}=0 to B_{g}=½B_{R} at l_{g}=lₘ. Because torque is a function of total machine flux φ according to Eq. 10, not gap flux density B_{g}, it is more instructive to rewrite Eq. 12 as:

$${A}_{g} {B}_{g} = ϕ = \frac{{B}_{R} {l}_{m}}{( \frac{{l}_{m}}{{A}_{m}} + \frac{{μ}_{r} {l}_{g}}{{A}_{g}} )} \qquad Eq . 13 A$$

Clearly, total machine flux diminishes as the rotor-stator gap length l_{g} increases, which is why conventional machine design typically attempts to keep the l_{g} as small as possible.
Optimal Gap for Maximum Torque at Given Efficiency:

Solving Eq. 11 for A_{g} B_{g} and inserting into Eq. 10 results in:

$$T = \frac{1}{2 π} I \frac{{B}_{R} {l}_{m}}{( \frac{{l}_{m}}{{A}_{m}} + \frac{{μ}_{r} {l}_{g}}{{A}_{g}} )} \qquad Eq . 14$$

As shown by Eq. 14, maximum torque occurs at l_{g}=0 because this condition would give maximum gap flux density B_{g}. In practice, however, at l_{g}=0 there would be no space available for copper, resulting in an infinitely high electrical resistance and zero machine efficiency. Conversely, an excessively large gap l_{g}, while lowering electrical resistance, would also reduce the flux density, and, consequently, torque would drop at a given current I. Therefore, at a specified efficiency there is an optimum value of gap length l_{g} that produces peak torque.

To find the optimum rotor-stator gap length l_{g}, begin by expressing motor efficiency as the ratio of mechanical power output to electrical power input:

$${E}_{ff} = \frac{{P}_{Shaft}}{{P}_{electric}} = \frac{{P}_{S}}{( {P}_{S} + {P}_{Ω} )} = \frac{1}{( 1 + \frac{{P}_{Ω}}{{P}_{S}} )} ; \qquad Eq . 15$$

where:
P_{S}=shaft power; and
P_{Ω}=resistive loss due to copper resistance

The importance of keeping resistive losses to a minimum to obtain good efficiency is shown by Eq. 15. The ratio P_{Ω}/P_{S} may be evaluated by first deriving the dissipative loss power P_{Ω}:
P_{Ω}=I²R; Eq. 16
where:
R=total rotor/stator resistance; and
I=total rotor/stator current

Machine resistance R is calculated using the dimensional information from FIG. 2:

$$R = \frac{2 σ {k}_{w} {w}_{g}}{{k}_{F} {A}_{copper}} ; \qquad Eq . 17$$

where:
“2”=multiplier to account for both rotor and stator conductors which are assumed to be identical in cross-sectional area and length;
σ=copper resistivity;
k_{w}=proportional multiplier that determines total conductor length as function of w_{g};
w_{g}=axial length of conductor immersed in the magnetic field as previously defined for Eq. 7;
k_{F}=copper fill-factor applied to copper area A_{copper}; and
A_{copper}=total area available for copper.
Solving Eq. 8 for w_{g} and inserting into Eq. 17:

$$R = \frac{2 σ {k}_{w} {A}_{g}}{2 π {r}_{g} {k}_{F} {A}_{copper}} = \frac{σ {k}_{w} {A}_{g}}{π {r}_{g} {k}_{F} {A}_{copper}} \qquad Eq . 18$$

Let copper area A_{copper} be expressed as:

$${A}_{copper} = 2 π {r}_{g} ( \frac{{l}_{g}}{2} ) = π {r}_{g} {l}_{g} ; \qquad Eq . 19$$

where l_{g}/2 accounts for half the radial rotor-stator gap length allocated equally between rotor copper and stator copper since rotor and stator conductors are connected in series. Inserting Eq. 19 into Eq. 18:

$$R = \frac{σ {k}_{w} {A}_{g}}{π {r}_{g} {k}_{F} π {r}_{g} {l}_{g}} = \frac{σ {k}_{w} {A}_{g}}{{π}^{2} {k}_{F} {r}_{g}^{2} {l}_{g}} \qquad Eq . 20$$

Substituting Eq. 20 into Eq. 16:

$${P}_{Ω} = {I}^{2} \frac{σ {k}_{w} {A}_{g}}{{π}^{2} {k}_{F} {r}_{g}^{2} {l}_{g}} \qquad Eq . 21$$

Let shaft power P_{S} be the product of torque T and angular shaft frequency ω using Eq. 14 for T:

$${P}_{S} = T ω = \frac{1}{2 π} I \frac{ω {B}_{R} {l}_{m}}{( \frac{{l}_{m}}{{A}_{m}} + \frac{{μ}_{r} {l}_{g}}{{A}_{g}} )} \qquad Eq . 22$$

Combining Eq. 21 and Eq. 22:

$$\begin{matrix}\frac{{P}_{Ω}}{{P}_{S}} = ( \frac{{I}^{2} σ {k}_{w} {A}_{g}}{{π}^{2} {k}_{F} {r}_{g}^{2} {l}_{g}} ) [ \frac{2 π ( \frac{{l}_{m}}{{A}_{m}} + \frac{{μ}_{r} {l}_{g}}{{A}_{g}} )}{I ω {B}_{R} {l}_{m}} ] \\ = I \frac{2 σ {k}_{w} ( \frac{{l}_{m} {A}_{g}}{{l}_{g} {A}_{m}} + {μ}_{r} )}{π {k}_{F} {r}_{g}^{2} ω {B}_{R} {l}_{m}}\end{matrix} \qquad Eq . 23$$

Solving Eq. 23 for current I:

$$I = \frac{π {k}_{F} ( {P}_{Ω} / {P}_{S} ) {B}_{R} ω {r}_{g}^{2} {l}_{m}}{2 σ {k}_{w} ( \frac{{l}_{m} {A}_{g}}{{l}_{g} {A}_{m}} + {μ}_{r} )} \qquad Eq . 24$$

Rewriting Eq. 14:

$$T = I \frac{{B}_{R} {l}_{m} {A}_{g}}{2 π {l}_{g} ( \frac{{l}_{m} {A}_{g}}{{l}_{g} {A}_{m}} + {μ}_{r} )} \qquad Eq . 25$$

Substituting Eq. 24 into Eq. 25:

$$\begin{matrix}T = \frac{π {k}_{F} ( {P}_{Ω} / {P}_{S} ) {B}_{R}^{2} ω {r}_{g}^{2} {l}_{m}^{2} {A}_{g}}{4 σ {k}_{w} π {{l}_{g} ( \frac{{l}_{m} {A}_{g}}{{l}_{g} {A}_{m}} + {μ}_{r} )}^{2}} \\ = \frac{{k}_{F} ( {P}_{Ω} / {P}_{S} ) {B}_{R}^{2} ω {r}_{g}^{2}}{4 σ {k}_{w}} [ \frac{{l}_{m}^{2} {A}_{g}}{{{l}_{g} ( \frac{{l}_{m} {A}_{g}}{{l}_{g} {A}_{m}} + {μ}_{r} )}^{2}} ]\end{matrix} \qquad Eq . 26$$

The variable configuration parameters are contained within the square brackets of Eq. 26 which may be simplified to give:

$$[ \frac{{l}_{m}^{2} {A}_{g}}{{{l}_{g} ( \frac{{l}_{m} {A}_{g}}{{l}_{g} {A}_{m}} + {μ}_{r} )}^{2}} ] = \frac{{A}_{g} {l}_{g}}{{( \frac{{A}_{g}}{{A}_{m}} + {μ}_{r} \frac{{l}_{g}}{{l}_{m}} )}^{2}} \qquad Eq . 27$$

Examination of Eq. 27 shows there is an optimal value of either A_{g} or l_{g} that gives a maximum value of the quantity within the square brackets [ ]. The optimal value of l_{g} is found by differentiating the entire bracketed quantity [ ] with respect to l_{g} and setting the result equal to zero so that:

$$\frac{ⅆ}{ⅆ {l}_{g}} [ ] = \frac{ⅆ}{ⅆ {l}_{g}} \frac{{A}_{g} {l}_{g}}{{( \frac{{A}_{g}}{{A}_{m}} + {μ}_{r} \frac{{l}_{g}}{{l}_{m}} )}^{2}} = 0 \qquad Eq . 28$$

$$\frac{ⅆ}{ⅆ {l}_{g}} [ ] = [ \frac{- 2 ( \frac{{μ}_{r}}{{l}_{m}} ) {l}_{g}}{{( \frac{{A}_{g}}{{A}_{m}} + {μ}_{r} \frac{{l}_{g}}{{l}_{m}} )}^{3}} + \frac{1}{{( \frac{{A}_{g}}{{A}_{m}} + {μ}_{r} \frac{{l}_{g}}{{l}_{m}} )}^{2}} ] = 0 \qquad Eq . 29$$

$$2 {μ}_{r} \frac{{l}_{g}}{{l}_{m}} = ( \frac{{A}_{g}}{{A}_{m}} + {μ}_{r} \frac{{l}_{g}}{{l}_{m}} ) \qquad Eq . 30$$

$${( {μ}_{r} \frac{{l}_{g}}{{l}_{m}} )}_{opt} = \frac{{A}_{g}}{{A}_{m}} \qquad Eq . 31$$

Rearranging the terms in Eq. 31:

$${( \frac{{l}_{g}}{{A}_{g}} )}_{opt} = \frac{1}{{μ}_{r}} ( \frac{{l}_{m}}{{A}_{m}} ) \qquad Eq . 32$$

Or:

$${( {μ}_{r} \frac{{l}_{g}}{{A}_{g}} )}_{opt} = \frac{{l}_{m}}{{A}_{m}} \qquad Eq . 32 A$$

Thus, the optimal shape of the rotor-stator gap, that is, the proportional relationship of rotor-stator gap length l_{g} to rotor-stator gap area A_{g}, is the same as the shape of the PM gap, except as modified by the multiplier (1/μᵣ), where μᵣ is the relative permeability of the PM material. Regardless of the absolute sizes of the rotor-stator gap and PM cavity volumes, their shape relative to each other is invariant as governed by Eq. 32. Furthermore, they may assume any imaginable shape, but nevertheless remain proportional to one another according to the dictates of Eq. 32.
Optimal rotor-stator gap length is found by solving Eq. 32 for (l_{g})ₒₚₜ:

$${( {l}_{g} )}_{opt} = \frac{1}{{μ}_{r}} {l}_{m} ( \frac{{A}_{g}}{{A}_{m}} ) \qquad Eq . 33$$

Torque at Optimized Rotor-Stator Gap:

Torque production under the optimized condition stipulated by Eq. 33 is found by substituting Eq. 31 into Eq. 27:

$$\begin{matrix}{[ ]}_{opt} = \frac{{{A}_{g} ( {l}_{g} )}_{opt}}{{( \frac{{A}_{g}}{{A}_{m}} + \frac{{A}_{g}}{{A}_{m}} )}^{2}} \\ = \frac{{{A}_{g} ( {l}_{g} )}_{opt}}{4 \frac{{A}_{g}^{2}}{{A}_{m}^{2}}} \\ = \frac{{{A}_{m}^{2} ( {l}_{g} )}_{opt}}{4 {A}_{g}}\end{matrix} \qquad Eq . 34$$

Substituting Eq. 33 into Eq. 34:

$$\begin{matrix}{[ ]}_{opt} = \frac{{{A}_{m}^{2} ( {l}_{g} )}_{opt}}{4 {A}_{g}} \\ = \frac{{A}_{m}^{2} {l}_{m} {A}_{g}}{4 {A}_{g} {μ}_{r} {A}_{m}} \\ = \frac{1}{4} \frac{{A}_{m} {l}_{m}}{{μ}_{r}}\end{matrix} \qquad Eq . 35$$

Substituting Eq. 35 into Eq. 26:

$$\begin{matrix}T = \frac{{k}_{F} ( {P}_{Ω} / {P}_{S} ) {B}_{R}^{2} ω {r}_{g}^{2}}{16 σ {k}_{w} {μ}_{r}} {A}_{m} {l}_{m} \\ = \frac{{k}_{F} ( {P}_{Ω} / {P}_{S} ) ω {r}_{g}^{2}}{16 σ {k}_{w}} ( \frac{{B}_{R}^{2} {A}_{m} {l}_{m}}{{μ}_{r}} )\end{matrix} \qquad Eq . 36$$

The term Aₘlₘ represents the volume of PM material which, aside from gap radius r_{g}, is the only dimensional variable pertinent to torque production.

Relative permeability μᵣ of the PM material is often not found in the technical literature. Typically the “energy product” of PM material is published which is actually the “energy density” in kJ/meter³ which may be used in Eq. 27 by rearranging formula for energy density.
Let:

$${E}_{tot} = \frac{{B}_{R}^{2} {A}_{m} {l}_{m}}{2 {μ}_{r} {μ}_{o}} = {E}_{ρ} {A}_{m} {l}_{m} ; \qquad Eq . 37$$

where:
Eₜₒₜ=total PM magnetic energy stored in the volume of Aₘlₘ;
E_{ρ}=magnetic “energy product” of PM material, i.e., energy per unit volume=kJ/meter³;
or: E_{ρ}=Eₜₒₜ/Aₘlₘ.
Then from Eq. 37:

$$( \frac{{B}_{R}^{2} {A}_{m} {l}_{m}}{{μ}_{r}} ) = 2 {μ}_{o} {E}_{ρ} {A}_{m} {l}_{m} \qquad Eq . 38$$

Inserting Eq. 38 into Eq. 36:

$$\begin{matrix}T = \frac{{k}_{F} ( {P}_{Ω} / {P}_{S} ) ω {r}_{g}^{2}}{16 σ {k}_{w}} 2 {μ}_{o} {E}_{ρ} {A}_{m} {l}_{m} \\ = \frac{{μ}_{o} {E}_{ρ} {k}_{F} ( {P}_{Ω} / {P}_{S} ) ω}{8 σ {k}_{w}} {r}_{g}^{2} {A}_{m} {l}_{m}\end{matrix} \qquad Eq . 39$$

Conversion Factors:

The following definitions and conversion constants may be used to convert Eq. 39 into English units:

$${μ}_{o} = ( 1.26 \times {10}^{- 6} ) \frac{volt - sec}{amp - meter} \qquad Eq . 40$$

$${σ}_{copper} = ( 1.7 \times {10}^{- 8} ) \frac{volt - meter}{amp} \qquad Eq . 41$$

$$\begin{matrix}ω = ( 2 π f ) \frac{1}{sec} \\ f = \frac{( rpm )}{60}\end{matrix} \qquad Eq . 42$$

$$\begin{matrix}{E}_{ρ} = \frac{( N - meter )}{{meter}^{3}} \\ = \frac{Nm}{{meter}^{3}} \\ = \frac{watt - sec}{{meter}^{3}} \\ = \frac{Joule}{{meter}^{3}}\end{matrix} \qquad Eq . 43$$

$$( 39.37 ) \frac{in}{meter} \qquad Eq . 44$$

$$( .7375 ) \frac{lb . ft .}{Nm} or ( 1.356 ) \frac{Nm}{lb . ft .} \qquad Eq . 45$$

$$B = \frac{volt - sec}{{meter}^{2}} = Telsa \qquad Eq . 46$$

$$\frac{{P}_{Ω}}{{P}_{S}} = ( \frac{1}{{E}_{ff}} - 1 ) from Eq . 15 \qquad Eq . 47$$

Rewriting Eq. 39 using Eqs. 40-44:

$$T = \frac{\begin{matrix}( 1.26 \times {10}^{{}^{- 6}} ) volt - \\ sec {k}_{F} ( {P}_{Ω} / {P}_{S} ) 2 π ( rpm ) {E}_{ρ} ( Newton - meter )\end{matrix}}{\begin{matrix}8 ( 1.7 \times {10}^{- 8} ) \frac{volt - meter}{amp} {k}_{w} amp - \\ meter ( 60 ) \frac{sec}{min} min - {meter}^{3}\end{matrix}} \frac{{r}_{g}^{2} {in}^{2} {A}_{m} {in}^{2} {l}_{m} in}{{( 39.37 )}^{3} \frac{{in}^{5}}{{meter}^{5}}} \qquad Eq . 48$$

All of the units cancel in Eq. 48, except for (Newton−meter) or Nm to use the common nomenclature. Thus torque in Eq. 48 is given in units of Newton-meters. Dropping the units in Eq. 48 for clarity gives:

$${T}_{Nm} = [ \frac{2 π ( 1.26 \times {10}^{- 6} )}{8 ( 1.7 \times {10}^{- 8} ) ( 60 ) {( 39.37 )}^{5}} ] \frac{{k}_{F}}{{k}_{w}} ( {P}_{Ω} / {P}_{S} ) ( rpm ) {E}_{ρ} {r}_{g - in}^{2} {A}_{m - in} {l}_{m - in} \qquad Eq . 49$$

$${T}_{Nm} = ( 1.025 \times {10}^{- 8} ) \frac{{k}_{F}}{{k}_{w}} ( {P}_{Ω} / {P}_{S} ) ( rpm ) {E}_{ρ} {r}_{g - in}^{2} {A}_{m - in} {l}_{m - in} \qquad Eq . 50$$

Using Eq. 45 to convert Eq. 50 to units of lb.ft.:

$${T}_{lb , ft} = ( 7.56 \times {10}^{- 9} ) \frac{{k}_{F}}{{k}_{w}} ( {P}_{Ω} / {P}_{S} ) ( rpm ) {E}_{ρ} {r}_{g - in}^{2} {A}_{m - in} {l}_{m - in} \qquad Eq . 51$$

Substituting Eq. 47 into Eq. 51:

$${T}_{lb . ft .} = ( 7.56 \times {10}^{- 9} ) ( \frac{1}{{E}_{ff}} - 1 ) \frac{{k}_{F}}{{k}_{w}} ( rpm ) {E}_{ρ} {r}_{g - in}^{2} {r}_{g - in}^{2} {A}_{m - in} {l}_{m - in} \qquad Eq . 52$$

The dimensional terms in Eqs. 49-52 reveal the “5^{th} Power Rule” where: r²A r→X⁵, which is applicable to all electromagnetic machines including non-mechanical devices such as transformers. This rule states that for a given efficiency, frequency and machine shape, power increases as the 5^{th} power of any dimension. Therefore, doubling the size of the machine will result in a 32-fold increase in power while weight only increase as the cube. Thus “specific power,” power per unit weight, varies as the square of machine size which means larger machines are more power-dense than smaller machines.

Equivalent Amp-Turns of PM Material:

The equivalent amp-turns (ni)_{PM eq}. that would be required to duplicate the mmf of PM material can be found starting with Eq. 37 where:

$${E}_{ρ} = \frac{{B}_{R}^{2}}{2 {μ}_{r} {μ}_{o}} \qquad Eq . 52 A$$

Therefore Eq. 1 may be rewritten by multiplying top and bottom by “2”, “B_{R}” and substituting Eq. 52A:

$$\begin{matrix}{( ni )}_{PM eq .} = \frac{{B}_{R} {l}_{m}}{{μ}_{r} {μ}_{o}} \\ = ( \frac{{B}_{R}^{2}}{2 {μ}_{r} {μ}_{o}} ) \frac{2 {l}_{m}}{{B}_{R}} \\ = 2 {l}_{m} ( \frac{{E}_{ρ}}{{B}_{R}} )\end{matrix} \qquad Eq . 52 B$$

Converting Eq. 52B to English units:

$${( ni )}_{PM eq . } = 2 {l}_{m} ( \frac{{E}_{ρ}}{{B}_{R}} ) = \frac{\begin{matrix}2 {l}_{m} - i {n}^{1} - {10}^{3} - {E}_{ρ - kJ / {m}^{3}} - {volt}^{1} - \\ amp - {sec}^{1} - {meter}^{2} - {meter}^{1}\end{matrix}}{{B}_{R} - {volt}^{1} - {sec}^{1} - {meter}^{3} - ( 39.37 ) {in}^{1}} \qquad Eq . 52 C$$

$${( ni )}_{PM - eq .} = ( 50.8 ) {l}_{m - in} \frac{{E}_{ρ - kJ / {m}^{3}}}{{B}_{R - Tesla}} \qquad Eq . 52 D$$

It should be understood that amp-turns (ni)_{PM eq.} as given by Eq. 52D is not the motor drive current, but rather the equivalent ni that would be required for creating the machine's static magnetic field electromagnetically rather than with PM material.

Reluctance Matching:

Motor torque is shown by Eqs. 49-52 to be dependent on the product of the PM gap area Aₘ and the PM gap length lₘ to give volume Aₘlₘ without regard to the particular shape of the PM cavity. Only the absolute volume Aₘlₘ is relevant to the magnitude of the torque developed. However, relative to machine efficiency, the shape of both volumes, the PM cavity and the rotor-stator gap volume, are of paramount importance, as shown by Eq. 32 under optimized conditions. It is the ratio of lₘ to Aₘ, i.e., PM gap shape, that determines rotor-stator gap shape at maximum efficiency, not their absolute values. Dividing both sides of Eq. 32 by absolute permeability μₒ gives:

$${( \frac{{l}_{g}}{{μ}_{o} {A}_{g}} )}_{opt} = ( \frac{{l}_{m}}{{μ}_{r} {μ}_{o} {A}_{m}} ) \qquad Eq . 53$$

These terms are simply expressions of the rotor-stator gap and PM gap reluctances as presented by Eq. 3. Therefore, Eq. 53 can be written as: [symbol]
_{g-opt}= [symbol] ₘ Eq. 54

Under optimal design conditions, the reluctances of both gaps are equal. This is because the electric circuit analogue, optimized for maximum power transfer, requires load resistance to be equal to the supply resistance, a condition known as “impedance matching”. The magnetic circuit counterpart to electrical resistance is termed “reluctance,” the resistance to flux flow. Eq. 54 specifies an equivalent “reluctance matching” in order to obtain maximum rotor-stator gap power from a given mmf, where the PM material is acting as the analogous “electrical power supply”.

Machine Flux Capacity:

To determine the rotor-stator gap flux density when the optimal design criteria are satisfied, Eq. 32A may be substituted into Eq. 12:

$${B}_{g - opt} = \frac{{B}_{R} {l}_{m}}{{A}_{g} ( \frac{{l}_{m}}{{A}_{m}} + \frac{{μ}_{r} {l}_{g - opt}}{{A}_{g}} )} = \frac{{B}_{R} {l}_{m}}{{A}_{g} ( \frac{{l}_{m}}{{A}_{m}} + \frac{{l}_{m}}{{A}_{m}} )} = \frac{1}{2} ( \frac{{A}_{m}}{{A}_{g}} ) {B}_{R} \qquad Eq . 55$$

Rearranging terms in Eq. 55:

$$\begin{matrix}{( {A}_{g} {B}_{g} )}_{opt} = \frac{1}{2} {A}_{m} {B}_{R} = {θ}_{opt} \\ Or \text{:} & Eq . 56 \\ {θ}_{opt} = \frac{1}{2} {θ}_{R} & Eq . 57\end{matrix}$$

According to Eqs. 56 and 57, circuit flux θₒₚₜ under optimal design parameters is half the value of flux θ_{R} that would exist under closed circuit conditions, wherein the rating of B_{R} is obtained. This result is achieved because the presence of the rotor-stator gap with an optimized design doubles the closed circuit reluctance (Eq. 54). Hence circuit flux would predictably drop to half the closed-circuit value. Measurement of total machine flux corresponds to half the PM magnet rating when the optimized criteria have been incorporated into the design. However, core cross-sectional area is designed to carry total machine flux near saturation so that closed-circuit flux is not obtained because of flux capacity limits imposed by saturation.

Relative Permeability of PM Material:

The value of the PM material's relative permeability μᵣ, according to Eq. 33, may be used to implement an optimized design. This value can be found by rearranging the terms in Eq. 38:

$${μ}_{r} = \frac{{B}_{R}^{2}}{2 {μ}_{o} {E}_{ρ}} \qquad Eq . 58$$

Thus, with the rated technical data of “residual induction”, i.e., flux density B_{R}, and “energy product” E_{ρ}, it is possible to calculate the relative permeability μᵣ for use in dimensional equations such as Eq. 33.
Converting Eq. 58 to English units using Eqs. 40, 43, 46:

$$\begin{matrix}{u}_{r} = \frac{{B}_{R}^{2} - {volt}^{2} - {sec}^{2} - {amp}^{1} - {meter}^{1} - {meter}^{3}}{\begin{matrix}2 - {meter}^{4} - ( 1.26 \times {10}^{- 6} ) - {volt}^{1} - {sec}^{1} - {E}_{ρ} - \\ ( {10}^{3} - {volt}^{1} - {amp}^{1} - {sec}^{1} )\end{matrix}} & Eq . 59 \\ \begin{matrix}{μ}_{r} = \frac{1}{2 ( 1.26 \times {10}^{- 6} ) {10}^{3}} \frac{{B}_{R}^{2}}{{E}_{ρ}} \\ = ( 397 ) \frac{{B}_{r}^{2}}{{E}_{ρ}} ;\end{matrix} & Eq . 60\end{matrix}$$

where energy product E_{ρ} is in units of kJ/meter³.

In the case of a Neodymium-Iron-Boron (NIB) “super magnet”, where B_{R}=1.21 Tesla and E_{ρ}=303 kJ/m³, the relative permeability calculated from Eq. 60 is μᵣ=1.92, a value that remains fairly constant among various NIB magnet grades.
Solving Eq. 33 for lₘ:

$${l}_{m} = {μ}_{r} ( \frac{{A}_{m}}{{A}_{g}} ) {l}_{g - opt} \qquad Eq . 61$$

In the particular case of Aₘ=A_{g} and μᵣ=1.92≈2, Eq. 61 results inn a PM cavity length lₘ that is almost twice as long as the rotor-stator gap length l_{g} at Aₘ=A_{g}.

Flux Density Inside of PM Material:

Substituting Eq. 6 into Eq. 11:

$${B}_{R} {l}_{m} = {A}_{m} {B}_{m} ( \frac{{l}_{m}}{{A}_{m}} + \frac{{μ}_{r} {l}_{g}}{{A}_{g}} ) \qquad Eq . 62$$

Solving Eq. 62 for Bₘ:

$${B}_{m} = \frac{{B}_{R} {l}_{m}}{{A}_{m} ( \frac{{l}_{m}}{{A}_{m}} + \frac{{μ}_{r} {l}_{g}}{{A}_{g}} )} \qquad Eq . 63$$

Inserting Eq. 32A into Eq. 63 to find Bₘ for an optimized design:

$$\begin{matrix}{B}_{m - opt} = \frac{{B}_{R} {l}_{m}}{{A}_{m} ( \frac{2 {l}_{m}}{{A}_{m}} )} \\ = \frac{1}{2} {B}_{R}\end{matrix} \qquad Eq . 64$$

Comparing Eq. 64 and Eq. 55 shows that B_{g-opt} and Bₘ₋ₒₚₜ are not the same. The difference is due to the fact that the PM gap of Bₘ₋ₒₚₜ is filled with PM material such that the circuit mmf (see Eq. 1) and cavity reluctance [symbol] ₘ both vary with a changing PM cavity volume. On the other hand, only the rotor-stator gap reluctance [symbol] _{g} varies with a changing rotor-stator gap volume while the circuit mmf remains constant.

To verify the veracity of Eqs. 55 and 64, solve Eq. 64 for B_{R} and substitute into Eq. 55:

$$\begin{matrix}{B}_{g - opt} = \frac{1}{2} ( \frac{{A}_{m}}{{A}_{g}} ) 2 {B}_{m - opt} \\ = \frac{{A}_{m} {B}_{m - opt}}{{A}_{g}}\end{matrix} \qquad Eq . 65$$

A_{g}B_{g-opt}=AₘBₘ₋ₒₚₜ or θ_{g}=φₘ Eq. 66

Eq. 66 results in a constancy of flux that is independent of circuit location, as previously indicated by Eq. 6.

Optimal Volume of PM Cavity:

Using the foregoing equations, a machine may be designed based on optimized parameters and yielding maximum performance. In order to maximize machine materials utilization, the iron core should operate near saturation because the quantity of flux φ and current I are the primary criteria governing torque production, as revealed by Eq. 10. The total flux φₘ produced by the PM cavity is given from Eq. 64 as:

$$\begin{matrix}{ϕ}_{m} = {A}_{m} {B}_{m} \\ = \frac{1}{2} {A}_{m} {B}_{R}\end{matrix} \qquad Eq . 67$$

The subscript “opt” has been dropped for simplification with the understanding that all parameters are hereafter considered optimal unless otherwise stated.

Flux is conducted axially through the rotor portion of the magnetic circuit at a flux density near saturation. Using Eq. 67 let:

$$\begin{matrix}{ϕ}_{m} = {ϕ}_{rotor } \\ = {A}_{rotor} {B}_{sat} \\ = \frac{1}{2} {A}_{m} {B}_{R} ;\end{matrix} \qquad Eq . 68$$

where:
Bₛₐₜ=saturation flux density
With reference to FIG. 2, rotor cross-sectional area is:
Aᵣₒₜₒᵣ=πr_{g}² eq. 69
Inserting Eq. 69 into Eq. 68:

$$π {r}_{g}^{2} {B}_{sat} = \frac{1}{2} {A}_{m} {B}_{R} \qquad Eq . 70$$

Solving Eq. 70 for PM cavity area Aₘ:

$${A}_{m} = 2 π {r}_{g}^{2} ( \frac{{B}_{sat}}{{B}_{R}} ) \qquad Eq . 71$$

According to Eq. 71, PM cavity area Aₘ varies only with gap radius r_{g} because both Bₛₐₜ and B_{R} are constants.
Solving Eq. 32A for PM cavity length lₘ under optimized conditions:

$${l}_{m} = {A}_{m} ( {μ}_{r} \frac{{l}_{g}}{{A}_{g}} ) \qquad Eq . 72$$

Inserting Eq. 71 into Eq. 72

$${l}_{m} = 2 {πμ}_{r} {r}_{g}^{2} \frac{{l}_{g}}{{A}_{g}} ( \frac{{B}_{sat}}{{B}_{R}} ) \qquad Eq . 73$$

An increase of rotor-stator gap area A_{g} results in a decrease of PM cavity length lₘ, which seemingly means a reduction in PM material usage and lower cost. But according to Eq. 39, machine torque T is a function of gap radius r_{g} and PM volume Aₘlₘ so that nothing is gained in terms of reducing the quantity of PM material per unit torque by enlarging the rotor-stator gap area A_{g}. Therefore, A_{g} is the minimum value necessary to conduct rotor flux. This means gap area A_{g} must be equal to rotor area Aᵣₒₜₒᵣ to maintain constant flux density near saturation Bₛₐₜ. Using Eq. 69:
A_{g}=Aᵣₒₜₒᵣ=πr_{g}² Eq. 74
Inserting Eq. 74 into Eq. 73:

$${l}_{m} = 2 π \backslash {μ}_{r} {r}_{g}^{2} \backslash \frac{{l}_{g}}{π \backslash {r}_{g}^{2} \backslash} ( \frac{{B}_{sat}}{{B}_{R}} ) = 2 {μ}_{r} {l}_{g} ( \frac{{B}_{sat}}{{B}_{R}} ) \qquad Eq . 75$$

Dimensions of the optimum PM cavity volume are given by Eq. 71 and Eq. 75. Combining these equations gives the total PM cavity volume as:

$${A}_{m} {l}_{m} = 4 {πμ}_{r} {r}_{g}^{2} {{l}_{g} ( \frac{{B}_{sat}}{{B}_{R}} )}^{2} \qquad Eq . 76$$

Torque Using Optimal PM Cavity Volume:

Machine torque produced with optimal PM volume may be found by substituting Eq. 76 into Eq. 39 for torque T:

$$\begin{matrix}T = \frac{{μ}_{o} {E}_{ρ} {k}_{F} ( {P}_{Ω} / {P}_{S} ) ω}{8 σ {k}_{w }} {r}_{g}^{2} 4 π {μ}_{r} {r}_{g}^{2} {{l}_{g} ( \frac{{B}_{sat}}{{B}_{R}} )}^{2} \\ = \frac{{μ}_{r} {μ}_{o} π {E}_{ρ} {k}_{F} ( {P}_{Ω} / {P}_{S} ) ω}{2 σ {k}_{w}} {( \frac{{B}_{sat}}{{B}_{R}} )}^{2} {r}_{g}^{4} {l}_{g}\end{matrix} \qquad Eq . 77$$

Rearranging terms in Eq. 77:

$$T = ( \frac{{μ}_{r} {μ}_{o} π}{2 σ} ) {{E}_{ρ} ( {B}_{sat} / {B}_{R} )}^{2} ( {k}_{F} / {k}_{w} ) ( {P}_{Ω} / {P}_{S} ) ω {r}_{g}^{4} {l}_{g} \qquad Eq . 78$$

Substituting Eq. 47 into Eq. 78:

$$T = ( \frac{{μ}_{r} {μ}_{o} π}{2 σ} ) {{E}_{ρ} ( {B}_{sat} / {B}_{R} )}^{2} ( {k}_{F} / {k}_{w} ) ( 1 / {E}_{ff} - 1 ) ω {r}_{g}^{4} {l}_{g} \qquad Eq . 79$$

At a specified efficiency E_{ff} and shaft frequency ω, machine torque is expressed in terms of two dimensions, rotor-stator gap radius r_{g} and rotor-stator gap length l_{g}, retaining the “5^{th} power rule” as before. Machine torque is extremely sensitive to gap radius r_{g}, varying as the fourth power of r_{g} for a given rotor-stator gap length l_{g}.
Rearranging terms in Eq. 79:

$$T = \frac{π}{2 σ} ( \frac{{μ}_{r} {μ}_{o} {E}_{ρ}}{{B}_{R}^{2}} ) {B}_{sat}^{2} ( {k}_{F} / {k}_{w} ) ( 1 / {E}_{ff} - 1 ) ω {r}_{g}^{4} {l}_{g} \qquad Eq . 80$$

From Eq. 58:

$$\frac{{μ}_{r} {μ}_{o} {E}_{ρ}}{{B}_{R}^{2}} = \frac{1}{2} \qquad Eq . 81$$

Inserting Eq. 81 into Eq. 80:

$$T = \frac{π}{4 σ} {B}_{sat}^{2} ( {k}_{F} / {k}_{w} ) ( 1 / {E}_{ff} - 1 ) ω {r}_{g}^{4} {l}_{g} \qquad Eq . 82$$

Converting Torque Equations to English Units:
Converting Eq. 82 to English units using Eqs. 41, 42, 46:

$$T = \frac{\begin{matrix}amp - π {B}_{sat}^{2} {volt}^{2 \backslash 1} - \\ {sec}^{2 \backslash 1} ( {k}_{F} / {k}_{w} ) ( 1 / {E}_{ff} - 1 ) 2 π ( rpm ) {min}^{1 \backslash} ( {r}_{g}^{4} {l}_{g} ) {in}^{5 \backslash} - {meter}^{5 \backslash}\end{matrix}}{\begin{matrix}4 ( 1.7 \times {10}^{- 8} ) {volt}^{1 \backslash} - {meter}^{1 \backslash} - {meter}^{4 \backslash} - \\ {min}^{1 \backslash} - ( 60 ) {{sec}^{1 \backslash} ( 39.37 )}^{5} {in}^{5 \backslash}\end{matrix}} \qquad Eq . 83$$

The units remaining are:
T=volt−amp−sec=watt−sec=Joules =Nm Eq. 84
Consolidating terms in Eq. 83:

$${T}_{Nm} = ( \frac{2 {π}^{2}}{4 ( 1.7 \times {10}^{- 8} ) ( 60 ) {( 39.37 )}^{5}} ) {B}_{sat}^{2} ( {k}_{F} / {k}_{w} ) ( 1 / {E}_{ff} - 1 ) ( rpm ) ( {r}_{g}^{4} {l}_{g} ) \qquad Eq . 85$$

T_{Nm}=(0.0512)B_{sat-Tesla}²(k_{F}/k_{w})(1/E_{ff}−1)(rpm)r_{g-in}⁴l_{g-in} Eq. 87
Using Eq. 45 to convert Eq. 86 to units of lb.ft.:
T_{lb.ft.}=(0.0377)B_{sat-Tesla}²(k_{F}/k_{w})(1/E_{ff}−1)(rpm)r_{g-in}⁴l_{g-in} Eq. 87
As a cross-check for errors in Eq. 87, substitute Eq. 58 into Eq. 76 for PM cavity volume Aₘlₘ:

$$\begin{matrix}{A}_{m} {l}_{m} = 4 {πμ}_{r} {r}_{g}^{2} {{l}_{g} ( \frac{{B}_{sat}}{{B}_{R}} )}^{2} \\ = {2}^{} π \frac{{R}_{2}^{}}{} ( \frac{{B}_{sat}^{2}}{{R}_{2}^{}} ) \\ = \frac{2 π}{{μ}_{o} {E}_{ρ}} {r}_{g}^{2} {l}_{g} {B}_{sat}^{2}\end{matrix} \qquad Eq . 88$$

Converting Eq. 88 to English units:

$$\begin{matrix}{A}_{m} {l}_{m} = \frac{\begin{matrix}2 π ( {r}_{g}^{2} {l}_{g} ) {in}^{3} - {B}_{sat}^{2} - volt - sec - \\ amp - meter - meter \end{matrix}}{\begin{matrix}( 1.26 \times {10}^{- 6} ) volt - sec - \\ meter {E}_{ρ} ( {10}^{3} ) ( volt - amp - sec )\end{matrix}} \\ = {in}^{3}\end{matrix} \qquad Eq . 89$$

$$\begin{matrix}{( {A}_{m} {l}_{m} )}_{{in}^{3}} = ( \frac{2 π}{( 1.26 \times {10}^{- 3} )} ) \frac{{B}_{sat - Tesla}^{2} {r}_{g - in}^{2} {l}_{g - in}}{{E}_{ρ}} \\ = ( 4.986 \times {10}^{3} ) \frac{{B}_{sat - Tesla}^{2} {r}_{g - in}^{2} {l}_{g - in}}{{E}_{ρ}} ;\end{matrix} \qquad Eq . 90$$

where energy product E_{ρ} is in units of kJ/meter³.
Substituting Eq. 90 for Aₘlₘ into Eq. 51 for torque T:

$${T}_{lb . ft .} = ( 7.56 \times {10}^{- 9} ) ( {k}_{F} / {k}_{w} ) ( 1 / {E}_{ff} - 1 ) ( rpm ) \backslash {E}_{ρ} {r}_{g \text{-} in}^{2} \frac{( 4.986 \times {10}^{6} ) {B}_{sat}^{2} {r}_{g \text{-} in}^{2} {l}_{g \text{-} in}}{\backslash {E}_{ρ}} \qquad Eq . 91$$

T_{lb.ft.}=(0.0377)B_{sat-Tesla}²(k_{F}/k_{w})(1/E_{ff}−1)(rpm)r_{g-in}⁴l_{g-in}=Eq. 87 Eq. 92
Drive Current:

To find drive current I required to produce torque under optimized design conditions, Eq. 14 may be expressed in terms of optimized quantities:

$${T}_{opt} = \frac{1}{2 π} I \frac{{B}_{R} {l}_{m}}{( \frac{{l}_{m}}{{A}_{m}} + {( \frac{{μ}_{r} {l}_{g}}{{A}_{g}} )}_{opt} )} \qquad Eq . 93$$

Substituting Eq. 32A into Eq. 93:

$$T = \frac{1}{2 π} I \frac{{B}_{R} {m}_{} {A}_{m}}{2 {m}_{}} = \frac{1}{4 π} I {A}_{m} {B}_{R} \qquad Eq . 94$$

Inserting Eqs. 56 and 57 into Eq. 94:

$$\begin{matrix}{T}_{opt} = \frac{1}{2 π} I \frac{( {A}_{m} {B}_{R} )}{2} \\ = \frac{1}{2 π} I \frac{{θ}_{R}}{2} \\ = \frac{1}{2 π} I {θ}_{opt} \\ = \frac{1}{2 π} I ( {A}_{g} {B}_{g} )\end{matrix} \qquad Eq . 95$$

Inserting Eq. 71 for Aₘ into Eq. 95:

$${T}_{opt} = \frac{1}{{2}_{} } I {R}_{} {r}_{g}^{2} ( \frac{{B}_{sat}}{{R}_{}} ) = \frac{1}{2} I {r}_{g}^{2} {B}_{sat} \qquad Eq . 96$$

Solving Eq. 96 for drive current I while dropping subscript “opt” inasmuch as optimization conditions have already been specified following Eq. 67:

$$I = \frac{2 T}{{r}_{g}^{2} {B}_{sat}} \qquad Eq . 97$$

Converting Eq. 97 to English units using Eqs. 43-46:

$$I = \frac{\begin{matrix}2 T - lb - ft - ( 1.356 ) - amp - \\ volt - sec - {meter}^{2} - {( 39.37 )}^{2} {in}^{2}\end{matrix}}{lb - ft - {r}_{g}^{2} - {in}^{2} - {B}_{sat} - volt - sec - {meter}^{2}} \qquad Eq . 98$$

$$I = ( 4.203 \times {10}^{3} ) = \frac{{T}_{lb . ft .}}{{r}_{g - in}^{2} {B}_{sat - Tesla}} \qquad Eq . 99$$

Induced Voltage:

Machine induced voltage v_{S}, which is typically referred to as “back emf” in a motor and “forward emf” in a generator, excludes resistive voltage drop. Induced voltage v_{S} is related only to mechanical power P_{S}.

From Eq. 22:
P_{S}=Tω=Iv_{S} Eq. 100
Solving Eq. 100 for machine voltage v_{S} and substituting Eq. 96 for torque T:

$${v}_{s} = ω \frac{T}{I} = \frac{1}{2} ω \frac{ {r}_{g}^{2} {B}_{sat}}{} = \frac{1}{2} ω {r}_{g}^{2} {B}_{sat} \qquad Eq . 101$$

Arriving at Eq. 101 using a different approach will validate the preceding equations from which it was derived. The familiar equation for voltage v_{S} induced in a conductor of length w_{g} moving at velocity V through a magnetic field of flux density B_{g} is:
v_{S}=Vw_{g}B_{g}; Eq. 102
where:
V=velocity of the conductor normal to the magnetic field; and
w_{g}=conductor length immersed in magnetic field=rotor/stator gap axial length
Let tangential velocity V be expressed in terms of angular frequency c:
V=ωr_{g} Eq. 103
From Eq. 6 for constancy of flux throughout the entire machine core, let:
φ_{g}=Φᵣₒₜₒᵣ Eq. 104
Or:
A_{g}B_{g}=AᵣₒₜₒᵣBₛₐₜ Eq. 105
Maximum core material utilization occurs when all of the iron is operating near saturation so that:
B_{g}=Bₛₐₜ
Therefore, substituting Eq. 106 into Eq. 105:
A_{g}=Aᵣₒₜₒᵣ
Expressing Eq. 107 in terms of rotor radius r_{g} and rotor-stator gap length w_{g}:
2πr_{g}w_{g}=πr_{g}² Eq. 108
Solving Eq. 108 for conductor length w_{g}:

$${w}_{g} = \frac{1}{2} {r}_{g} \qquad Eq . 109$$

Substituting Eqs. 103, 106 and 109 into Eq. 102:

$$\begin{matrix}{v}_{S} = ( ω {r}_{g} ) \frac{1}{2} {r}_{g} {B}_{sat} \\ = \frac{1}{2} ω {r}_{g}^{2} {B}_{sat} \\ = Eq . 101\end{matrix} \qquad Eq . 110$$

Converting Eq. 110 to English units:

$${v}_{S} = \frac{\begin{matrix}2 π ( RPM ) - min - {r}_{g}^{2} - {in}^{2} - \\ {meter}^{2} - {B}_{sat - Telsa} - volt - sec\end{matrix}}{2 - min - 60 - sec - {( 39.37 )}^{2} - {in}^{2} - {meter}^{2}} \qquad Eq . 111$$

v_{S}=(3.378×10⁻⁵)(RPM)r_{g-in}²B_{sat-Tesla} Eq. 112

It should be understood that machine voltage v_{S} as given by Eq. 112 is not the applied terminal voltage, but rather the voltage arising from mechanical power which excludes resistive voltage drop across the copper conductors.

Ratio of PM Cavity Area to Rotor-Stator Gap Area:

Substituting Eq. 106 into Eq. 55 gives the ratio of PM cavity cross-sectional area Aₘ relative to the rotor-stator gap area A_{g}:

$$\begin{matrix}{B}_{g} = {B}_{sat} = \frac{1}{2} \frac{{A}_{m}}{{A}_{g}} {B}_{R} \\ Then \text{:} & Eq . 113 \\ \frac{{A}_{m}}{{A}_{g}} = 2 ( \frac{{B}_{sat}}{{B}_{R}} ) & Eq . 114\end{matrix}$$

From the above equation it may be deduced that if Bₛₐₜ=B_{R} then A_{g}=½Aₘ. This results because machine flux is half the closed-circuit value due to double the reluctance relative to the closed-circuit reluctance at which B_{R} is rated. Also, the area ratio of Eq. 114 is constant irrespective of absolute machine size, being a function of magnetic properties only.

Ratio of PM Cavity Volume to Rotor-Stator Gap Volume:

From Eq. 74 let:
A_{g}l_{g}=πr_{g}²l_{g} Eq. 115
Dividing Eq. 76 for Aₘ lₘ by Eq. 115:

$$\frac{{A}_{m} {l}_{m}}{{A}_{g} {l}_{g}} = \frac{4 {μ}_{r} {g}_{2}^{} {g}_{}}{ {g}_{2}^{} {g}_{}} {( \frac{{B}_{sat}}{{B}_{R}} )}^{2} = 4 {{μ}_{r} ( \frac{{B}_{sat}}{{B}_{R}} )}^{2} \qquad Eq . 116$$

According to Eq. 116, the ratio of the PM cavity vs. rotor-stator volume is constant regardless of absolute volume size. The volume ratio is strictly a function of magnetic properties independent of machine geometry or structural dimensions.

Examining Eq. 33 and Eq. 116 shows that the shape (Eq. 33) and size (Eq. 116) of the PM cavity corresponds to the shape and size of the rotor-stator gap volume that is chosen to satisfy a particular mechanical design, or vice-versa. In other words, both the shape and size of the rotor-stator gap volume are independent variables, while the PM cavity shape and size are dependent upon the rotor-stator geometry (or vice-versa) according to the dictates of Eqs. 33 and 116.

Summary of Equations

The dimensional parameters, given in “inch” units, of an optimized machine are summarized here with reference to FIG. 2.
From Eq. 71:

$$\begin{matrix}{A}_{m} = 2 π {r}_{g}^{2} ( \frac{{B}_{sat}}{{B}_{R}} ) \\ = π ( {r}_{o}^{2} - {r}_{g}^{2} ) ;\end{matrix} \qquad Eq . 117$$

where:
rₒ=outside radius of PM cavity
Solving Eq. 113 for PM cavity outside radius rₒ:

$${r}_{o - in} = {{r}_{g - in} [ 1 + 2 ( \frac{{B}_{sat}}{{B}_{R}} ) ]}^{1 / 2} \qquad Eq . 118$$

Rewriting Eq. 109:

$${w}_{g - in} = \frac{1}{2} {r}_{g - in} \qquad Eq . 119$$

PM cavity length lₘ is taken from Eq. 75:

$${l}_{m - in} = 2 {μ}_{r} {l}_{g - in} ( \frac{{B}_{sat}}{{B}_{R}} ) \qquad Eq . 120$$

Because the PM relative permeability μᵣ is not usually published, it may be calculated from Eq. 60, repeated here for convenience:

$${μ}_{r} = ( 397 ) \frac{{B}_{R}^{2}}{{E}_{ρ}} \qquad Eq . 121$$

Typically μᵣ≈1.92 for neodymium-iron-boron magnets. (See the calculation following Eq. 60)

Substituting Eq. 121 into Eq. 120 as an alternative expression for PM cavity length lₘ using published data of “residual induction” B_{R} and “energy product” E_{ρ}:

$$\begin{matrix}{l}_{m - in} = 2 ( 397 ) ( \frac{B {R}_{1}^{}}{{E}_{ρ}} ) {l}_{g - in} ( \frac{{B}_{sat}}{B {R}_{}} ) \\ = ( 794 ) {l}_{g - in} ( \frac{{B}_{R} {B}_{sat}}{{E}_{ρ}} ) ;\end{matrix} \qquad Eq . 122$$

where flux density B is always in units of “Tesla” and “energy product” Eₚ is in units of kJ/meter³

If the PM cavity length lₘ is known in advance, then the rotor-stator gap length l_{g} is derived from Eq. 122:

$${l}_{g - in} = ( .00126 ) {l}_{m - in} ( \frac{{E}_{ρ}}{{B}_{R} {B}_{sat}} ) \qquad Eq . 123$$

Total volume of PM material is found from Eq. 90:

$${( {A}_{m} {l}_{m} )}_{{in}^{3}} = ( 4.986 \times {10}^{3} ) \frac{{B}_{sat - Tesla}^{2} {r}_{g - in}^{2} {l}_{g - in}}{{E}_{ρ - kJ \text{/} {m}^{3}}} ; \\ where \\ {E}_{ρ} = kJ \text{/} {m}^{3} \qquad Eq . 124$$

Let the weight W_{i-PM} of PM material be given as:

$$\begin{matrix}{( {W}_{t - PM} )}_{lbs} = ( {A}_{m - in} {l}_{m - in} ) {ρ}_{PM} \\ = ( {A}_{m - in} {l}_{m - in} ) ( .272 ) \frac{lb}{{in}^{3}} ;\end{matrix} \\ where \text{:} \\ {ρ}_{PM} = PM material density of approximately ( .272 ) lb \text{/} {in}^{ 3} \qquad Eq . 125$$

Substituting Eq. 124 into Eq. 125:

$${( {W}_{t - PM} )}_{lbs} = ( 1.35 \times {10}^{3} ) \frac{{B}_{sat - Tesla}^{2} {r}_{g - in}^{2} {l}_{g - in}}{{E}_{ρ - kJ \text{/} {m}^{3}}} \qquad Eq . 126$$

Repeated here for convenience are Eq. 92 and Eq. 52 for torque T:
T_{lb.ft.}=(0.0377)B_{sat-Tesla}²(k_{F}/k_{w})(1/E_{ff}−1)(rpm)r_{g-in}⁴l_{g-in} Eq. 127
T_{lb.ft.}=(7.56×10⁻⁶)(k_{F}/k_{w})(1/E_{ff}−1)(rpm)E_{ρ-kJ/m}_{³}r_{g-in}²Aₘ₋ᵢₙlₘ₋ᵢₙ; Eq. 128
where:
Energy product E_{ρ} has been changed to units of kJ/m³ in Eq. 124.

The DC homopolar motor/generator described herein specifies design parameters for achieving maximum torque at a given efficiency. Theoretical analysis reveals that optimum performance is obtained when the rotor-stator gap shape and size yields a total machine flux that is half of the closed-circuit flux content. (Closed-circuit flux is defined as the flux that would exist with a rotor-stator gap length of zero.) This ideal design condition is achieved when the machine's total magnetic circuit reluctance is divided equally between the reluctance of the PM cavity (filled with PM material) and the rotor-stator gap reluctance. The resulting “reluctance matching” is analogous to “impedance matching” in electrical circuits for maximum power transfer.

The optimized gap length of the DC homopolar motor/generator described herein is many times larger than that of a conventional homopolar machine. Although machine flux for a given amount of PM material is significantly less than found in standard practice, the attendant large copper volume permits high current at low dissipation to yield the highest torque theoretically possible from a given quantity of PM material.

This written description uses examples to disclose the invention, including the best mode, and also to enable a person skilled in the art to make and use the invention. The patentable scope of the invention may include other examples that occur to those skilled in the art.

It is claimed:

1. A DC homopolar machine, comprising:
a stator that includes a stator magnetic core and a permanent magnet;
a rotor magnetic core supported within the stator to rotate relative to the stator;
a non-magnetic material within a gap between the rotor magnetic core and the stator magnetic core; and
the stator, rotor and non-magnetic material forming a magnetic circuit having a total reluctance, the total reluctance of the magnetic circuit being provided by a first reluctance of the permanent magnet and a second reluctance of the gap of non-magnetic material, with the first reluctance being substantially equal to the second reluctance.

2. The DC homopolar machine of claim 1, wherein the non-magnetic material includes copper.

3. The DC homopolar machine of claim 1, wherein the non-magnetic material includes air.

4. The DC homopolar machine of claim 1, wherein the non-magnetic material includes a rotor copper conductor coupled to the rotor magnetic core and a stator copper conductor coupled to the stator magnetic core.

5. The DC homopolar machine of claim 4, wherein the non-magnetic material further includes an air gap between the rotor copper conductor and the stator copper conductor.

6. The DC homopolar machine of claim 1, wherein the DC homopolar machine is a motor.

7. The DC homopolar machine of claim 1, wherein the DC homopolar machine is a generator.

8. The DC homopolar machine of claim 1, wherein the DC homopolar machine may operate as either a motor or a generator.

9. The DC homopolar machine of claim 1, wherein a ratio of a length and a cross-sectional area of the permanent magnet is substantially equal to a ratio of a length and a cross-sectional area of the gap between the rotor magnetic core and the stator magnetic core multiplied by a relative permeability of the permanent magnet.

10. The DC homopolar machine of claim 9, wherein the cross-sectional area of the permanent magnet is substantially equal to the cross-sectional area of the gap between the rotor magnetic core and the stator magnetic core multiplied by twice the core flux density divided by the residual induction flux density of the permanent magnet.

11. The DC homopolar machine of claim 10, wherein the length of the permanent magnet is substantially equal to the length of the gap between the rotor magnetic core and the stator magnetic core multiplied by twice the relative permeability of the permanent magnet multiplied by the core flux density divided by the residual induction flux density of the permanent magnet.

12. The DC homopolar machine of claim 1, wherein a cross-section area defined by the permanent magnet is about a minimum area necessary to conduct total machine flux at a flux density of half the residual induction flux density of the permanent magnet.
